(19) United States
(12) Patent Application Publication
(10) Pub. No.: US 2015/0029259 A1
(43) Pub. Date: Jan. 29, 2015

(54) Printing systems and methods

(71) Applicants: Jacint Humet, Barcelona (ES); Marc Vall Serra, Barcelona (ES); Jaime Fernandez, Barcelona (ES); Eduardo Amela, Lleida (ES)

(72) Inventors: Jacint Humet, Barcelona (ES); Marc Vall Serra, Barcelona (ES); Jaime Fernandez, Barcelona (ES); Eduardo Amela, Lleida (ES)

(73) Assignee: Hewlett-Packard Development Company, L.P., Houston, TX (US)

(21) Appl. No.: 14/352,152

(22) PCT Filed: Oct. 21, 2011
(86) PCT No.: PCT/EP2011/068450

§ 371 Date: Apr. 16, 2014

(51) Int. Cl. B41J 11/00; B41J 2/14

(52) U.S. Cl. CPC B41J 11/0015; B41J 2/14
USPC 347/21

(57) ABSTRACT

Methods performed by printing systems (10) are described herein. An ink printhead (38, 40, 42, 44) and a treatment printhead (46, 48) traverse over a print area (84) in a forward direction (50) and a backward direction (52). In one of the forward direction or the backward direction the treatment printhead trails behind the ink printhead. In the other direction the treatment printhead leads before the ink printhead. The treatment printhead ejects treatment fluid for treating the print area depending on the traversing direction. Printing systems (10) and tangible machine readable storage media (64) are also described herein.

### BACKGROUND

Some printing systems form a printed image by ejecting ink from ink printheads. Thereby, ink is applied onto a print medium for printing a pattern of individual dots at particular locations. The printed pattern reproduces an image on the printing medium. At least some of these printing systems are commonly referred to as inkjet printers.

At least some printing systems provide means for applying a treatment fluid on the print area in order to treat the print area on which ink is printed. For example, the treatment fluid may be a fixer fluid to address coalescence, bleed, or similar effects characterized by ink migration across a printed surface. Another example of treatment fluid is a durability enhancer coating including polymers.

A printing system may include a treatment printhead to apply a treatment fluid by ejection over a particular location for ink placement. A treatment fluid may be applied to a particular print area before, after or, quasi-simultaneously to the application of the ink to that print area. However, though a treatment fluid may improve print quality, undesirable cross-contamination can occur by one of several mechanisms. For example, migration of aerosol droplets from a treatment fluid that is jetted from a treatment printhead can cross-contaminate other printheads.

### BRIEF DESCRIPTION OF THE DRAWINGS

The Figures depict examples, implementations, and configurations of the invention, and not the invention itself.

FIG. 1 is a perspective view of a printing system according to an example.

FIG. 2 is a block diagram of a printing system according to an example.

FIG. 3 is another block diagram of the printing system of FIG. 2.

FIG. 4 is a process flow diagram of a method performed by a printing system according to an example herein.

FIGS. 5A, 5B are simplified diagrams of arrangements for a printing process according to examples herein.

FIGS. 6A to 6C are simplified diagrams of an arrangement for a printing process according to examples herein.

FIGS. 7A to 7C are simplified diagrams of an arrangement for a printing process according to examples herein.

FIGS. 8A to 8C are simplified diagrams of an arrangement for a printing process and a printed pattern according to examples herein.

FIGS. 9A to 9D are simplified diagrams of an arrangement for a printing process and a printed pattern according to examples herein.

### DETAILED DESCRIPTION

In the foregoing description, numerous details are set forth to provide an understanding of the examples disclosed herein. However, it will be understood by those skilled in the art that the examples may be practiced without these details. Further, in the following detailed description, reference is made to the accompanying figures, in which various examples are shown by way of illustration. In this regard, directional terminology, such as “top,” “bottom,” “front,” “back,” “left,” “right,” “vertical,”, etc., is used with reference to the orientation of the figures being described. Because disclosed components can be positioned in a number of different orientations, the directional terminology is used for purposes of illustration and is in no way limiting. Like numerals are used for like and corresponding parts of the various figures.

While a limited number of examples have been disclosed, those skilled in the art will appreciate numerous modifications and variations therefrom. It is intended that the appended claims cover such modifications and variations.

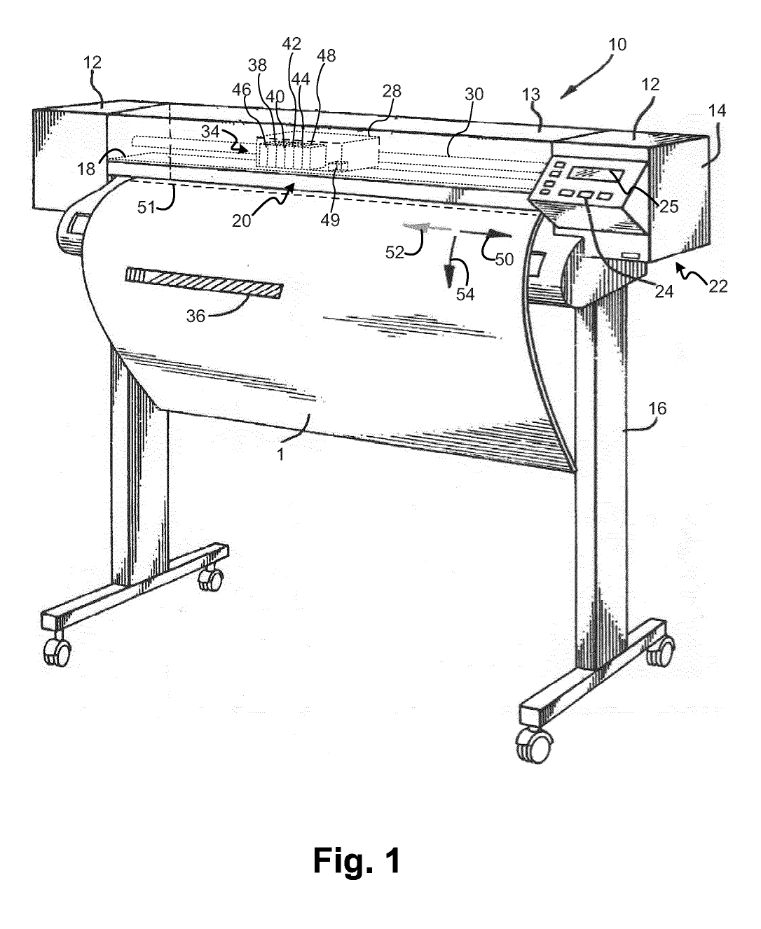

FIG. 1 shows a schematic view of a printing system 10 according to an example. Printing system 10 is exemplified as an industrial printer, i.e., a printer designed for use in: a) manufacturing, b) production lines, and/or c) large scale printing (both size and production) printing. Printing system 10 may be, for example, an inkjet plotter. It will be understood that a printing system as used herein is not limited to an industrial printer, but also may include other types of printing systems such as, but not limited to, printers for printing small/average size printing media (e.g., desktop printers or portable printers).

Printing system 10 includes a housing 12 enclosing a chassis (not shown) forming a print assembly 14. Print assembly 14 is supported by a leg assembly 16. It will be understood that print assembly 14 may be designed to be supported by a desktop during operation. A print media transport assembly 18 feeds a print medium 1 through a print zone 20 and advances print medium 1 in a media advance direction 54. Printing system 10 includes a user terminal 22 for receiving user inputs through, e.g., a keypad 24, and providing visual feedback to the user through, e.g., a display 25. It will be understood that user interaction may be implemented by other suitable means such as a personal computer operatively connected to printing system 10.

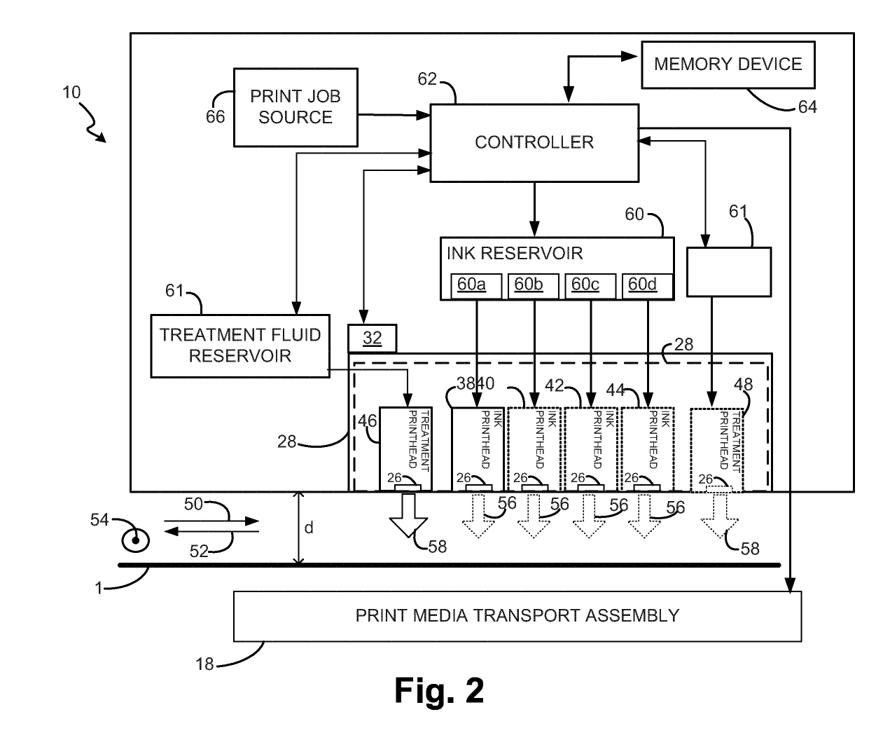

A carriage 28 is slidably mounted on a guide rod 30. Guide rod 30 defines a carriage transition axis 51 along which carriage 28 traverses over print zone 20 for performing printing. A carriage drive 32 (shown in FIG. 2) actuates carriage 28 for effecting the carriage transition. Thereby, carriage 28 is reciprocally translatable in a forward direction 50 (e.g., left-to-right) and a backward direction 52 (e.g., right-to-left) over print zone 20. Carriage 28 and guide rod 30 are enclosed by a hood 13.

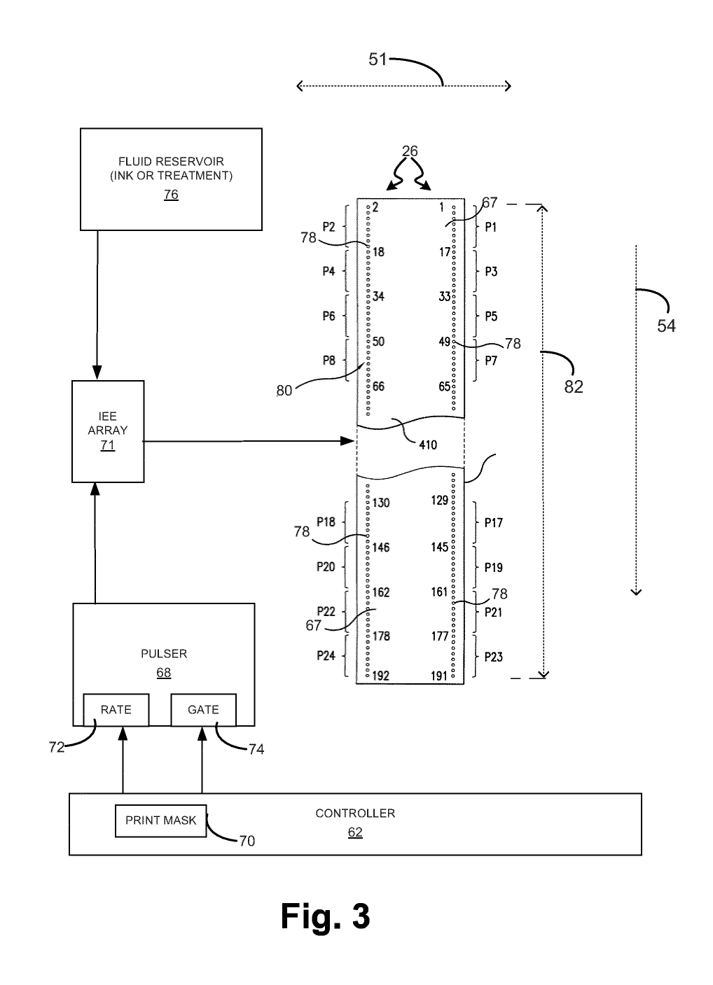

Carriage 28 includes positions for receiving respective printheads therein. As used herein, a printhead is a device including a nozzle or a group of nozzles (such as nozzle array 26 depicted in FIG. 3) through which drops of a fluid (e.g., a treatment fluid or an ink) can be ejected. Printhead assembly 34 is operated for ejecting ink and treatment fluid so as to print a printing pattern 36 on print medium 1. As used herein, “ink” refers to a solution composition that includes a liquid vehicle and a colorant for reproducing an image on a print medium. As used herein, “treatment fluid” refers to a solution composition used in a printing system for improving print quality. A treatment fluid may function by, for example, (i) chemically reacting with ink in a print medium (e.g., a gloss enhancer) or (ii) physically reacting with the ink (e.g., a durability enhancer coating using polymers).

In the example illustrated in FIG. 1, carriage 28 includes six positions for a printhead assembly 34: two positions are for treatment printheads and four positions are for ink printheads. Further examples of configurations of carriage 28 are illustrated below in a non-limiting manner. Ink printheads 38, 40, 42, 44 are configured for ejecting ink through one or more nozzles over a print area; treatment printheads 46, 48 are configured to eject treatment fluid for treating the print area. Carriage 28 may also include an alignment sensor 49 for estimating alignment of a printhead.

Treatment fluid ejected for treating printing ink on a print area may cause cross-contamination in an ink printhead. Cross-contamination may compromise performance of the ink printhead. For example, a treatment fluid including a fixer may cause that fixer reacts with ink at the nozzles of an ink printhead so that ink remains attached at the nozzle exits.

A mechanism for cross-contamination involves aerosol formation. Aerosol can form when ejected drops of treatment fluid divide into one or more primary droplets. (Satellite droplets may also result from the tail of ejected droplets becoming divided.) Aerosol generation may depend on a) the particularly used treatment fluid, b) the distance between the treatment printhead and the print medium (also referred to as printhead-media distance), c) carriage transition speed, and/or d) quantity of ejected treatment fluid. For example, the greater the printhead-media distance, the greater the quantity of aerosol that a treatment printhead may generate. In every case, even when the printhead-media is relatively small, a non-negligible risk exists that fluid ejected for treating printing ink on a print media generates aerosol. Even when aerosol generation is relatively low, cross-contamination may affect operation of an ink printhead, eventually, after a relatively long operational period of the printhead.

The present disclosure describes methods and systems for printing that facilitate prevention of cross-contamination caused by treatment fluid ejected for treating printing ink or the print area on which the printing ink is to be applied. Treatment fluid is ejected depending on the particular traversing direction of the carriage over a print area. As used herein, “printing ink” refers to ink ejected over a print area for reproducing an image portion thereon. Different examples of treatment fluid ejection depending on the particular traversing direction of the carriage are set forth below.

For example, printing may be performed such that the carriage traverses over a print area in a forward direction and a backward direction. During this transition, a specific amount of treatment fluid is to be ejected for treating the print area. In one of the forward direction or the backward direction, the treatment printhead trails behind the ink printhead. In the other direction, the treatment printhead leads before the ink printhead.

When the treatment printhead leads, the risk of cross-contamination is higher, since the ink printhead crosses the ejection area immediately after treatment fluid ejection. On the other hand, when the treatment printhead trails, the risk of cross-contamination is lower, since the ink printhead does not cross the ejection area immediately after aerosol generation by the preceding printhead. Therefore, in order to prevent cross-contamination, a portion of the treatment fluid for treating fluid on the print area may be ejected while the carriage traverses in the direction in which the treatment printhead trails behind the ink printhead. In some examples, most or all of the treatment fluid for treating fluid on the print area is ejected while a treatment printhead trails so as to further prevent cross-contamination. In the following, further examples are illustrated.

FIG. 2 is a block diagram of printing system 10. As shown in the diagram, each of ink printheads 38, 40, 42, 44 is configured to eject ink 56 of a different color through nozzle arrays 26. In particular, ink printheads 38, 40, 42, 44 are fluidly connected to an ink reservoir 60. Ink reservoir 60 includes separated ink reservoirs 60a, 60b, 60c, 60d for providing ink to the respective ink printhead. In the illustrated example, separated ink reservoirs 60a, 60b, 60c, 60d respectively store cyan ink, magenta ink, yellow ink, and black ink. Base colors are reproduced on print medium 1 by depositing a drop of one of the above mentioned inks corresponding to the desired base color onto a dot location. A plurality of ink printheads enables reproduction of secondary colors by combining ink from different ink printheads. In particular, secondary or shaded colors are reproduced by depositing drops of different base colors on adjacent dot locations; the human eye interprets the color mixing as the secondary color or shading.

Treatment printheads 46, 48 are configured to eject a treatment fluid 58 through nozzle arrays 26 for treating ink in a print area of print medium 1. Application of the treatment fluid on a particular spot of a print area may be performed before, substantially simultaneously, or after application of the ink for reproducing a particular color on that spot. The block diagram shows that treatment printheads 46, 48 are fluidly connected to a treatment fluid reservoir 61. The printheads are separated from print medium 1 a printhead-media distance d.

Ink reservoir 60 and treatment fluid reservoir 61 may include disposable cartridges (not shown). The reservoirs may be mounted on carriage 28 in a position adjacent to the respective printhead. In other configurations (also referred to as off-axis systems), a small fluid supply (ink or treatment) is provided to cartridges (not shown) in carriage 28, each cartridge being associated to a respective printhead; main supplies for ink and fixer are then stored in the respective reservoirs. In an off-axis system, flexible conduits are used to convey the fluid from the off-axis main supplies to the corresponding printhead cartridge. Printheads and reservoirs may be combined into single units, which are commonly referred to as “pens”.

It will be appreciated that examples can be realized with any number of printheads depending on the design of the particular printing system. For example, printing system 10 may include at least one treatment printhead, such as two or more treatment printheads. Furthermore, printing system 10 may include at least one ink printhead, such as two to six ink printheads, or even more ink printheads. Further, a printhead of printing system 10 may be a disposable printhead or a fixed printhead, which is designed to last for the whole operating life of printing system 10. In the illustrated examples, ink printheads are disposed at one side of a treatment printhead. It will be understood that ink printheads may be disposed at both sides of a treatment printhead.

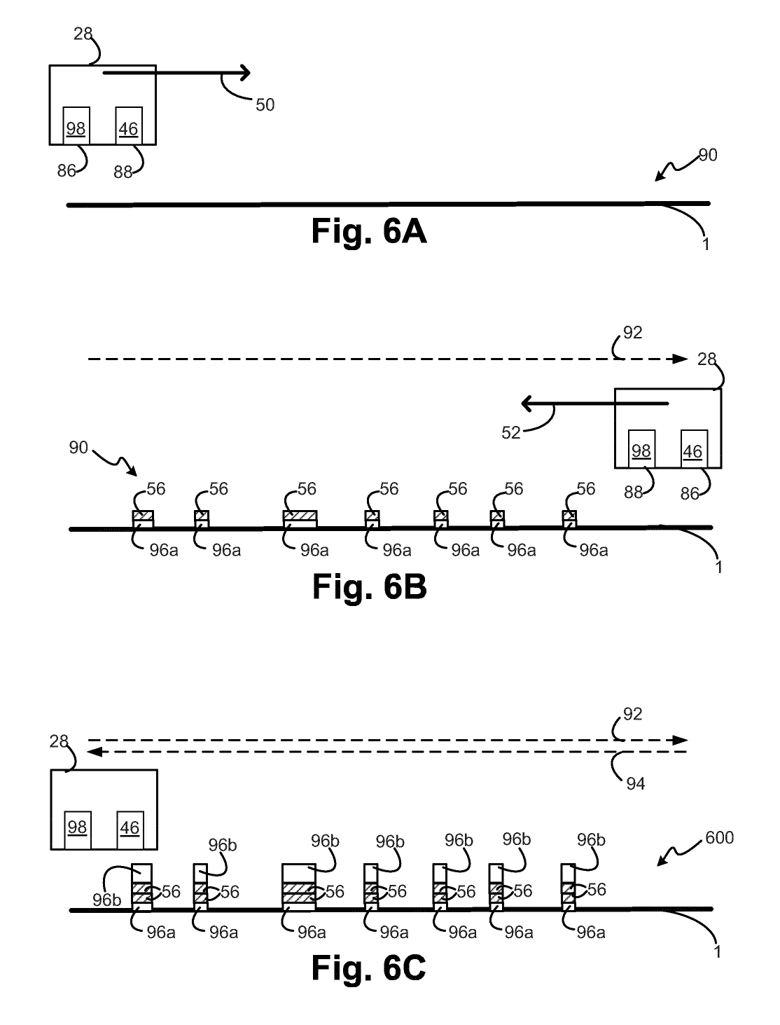

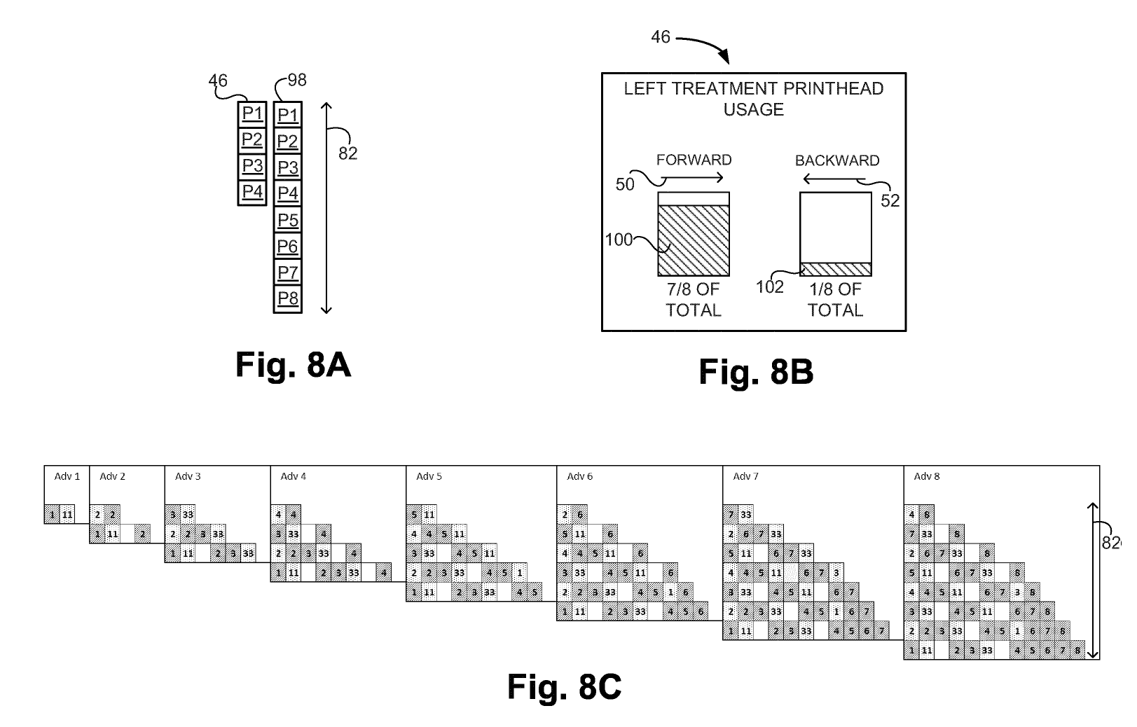

The carriage may include one treatment printhead. In the example illustrated in FIG. 2, treatment printhead 46 or treatment printhead 48 may by the single treatment printhead in carriage 28; one or more ink printheads, such as ink printheads 38, 40, 42, 44, may be arranged at one side of the treatment printhead. An example of operation of printing systems with one treatment printhead is illustrated with respect to FIGS. 6A to 6C, and 8A to 8C.

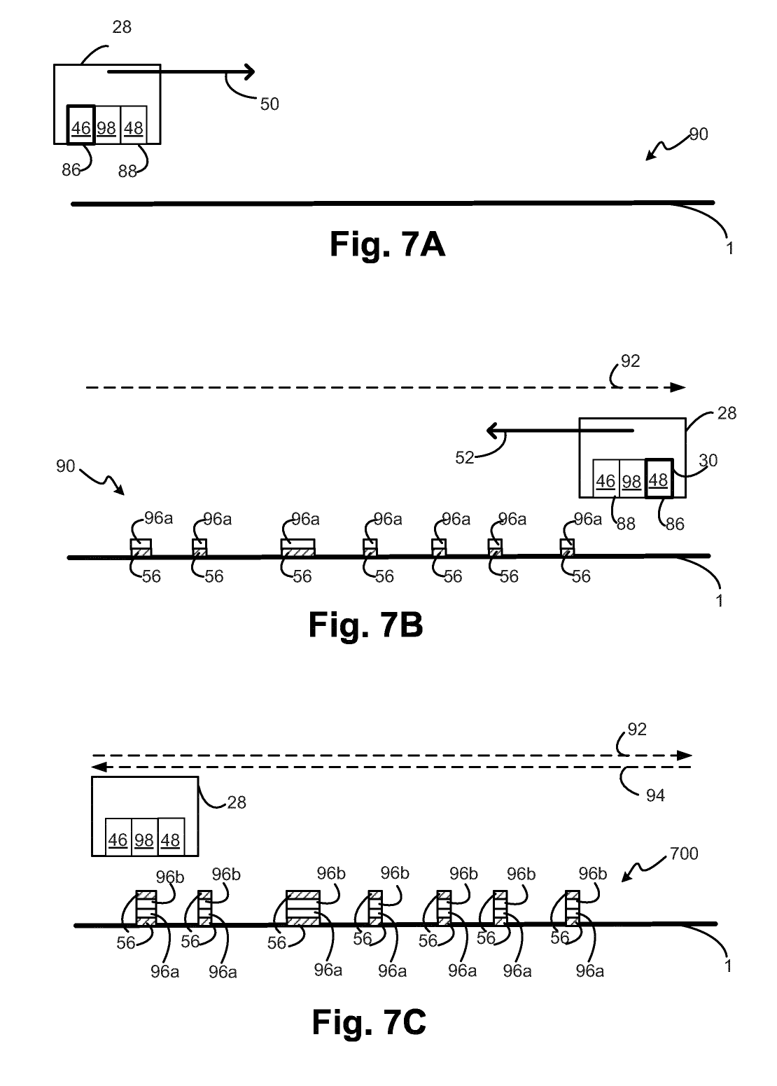

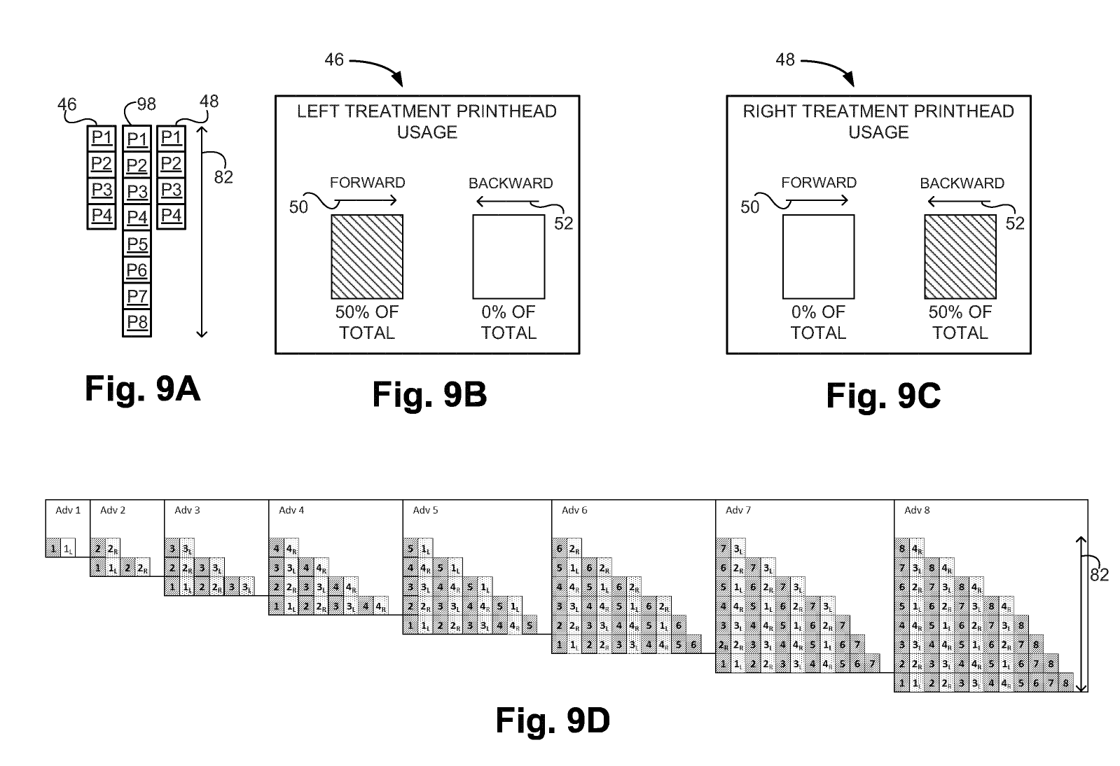

In other examples herein, the carriage includes at least two treatment printheads disposed along a transition axis of the carriage (e.g., an axis parallel to guide rod 30). At least one ink printhead may be disposed between the treatment printheads. For example, as illustrated in FIG. 1. An example of operation of printing systems with a double treatment printhead configuration is illustrated with respect to FIGS. 7A to 7C and 9A to 9D.

In the illustrated examples, unless a treatment printhead is completely offset from an ink printhead along an axis coincident with media advance direction 54, a treatment printhead trails or leads relative to the ink printheads during a carriage transition for printing. In the configuration illustrated in FIG. 2, during carriage transition treatment printhead 46 trails behind the ink printheads in forward direction 50 and leads before the ink printheads in backward direction 52. On the other hand, treatment printhead 48 leads before the ink printheads in forward direction 50 and trails behind the ink printheads in backward direction 52. Therefore, whether a treatment printhead is at trailing or at leading relative to an ink printhead depends on the particular printhead arrangement and the particular carriage transition direction.

The printheads may be arranged according to a linear configuration, in which the printheads are aligned along the direction of carriage transition (e.g., carriage transition axis 51). Such a linear configuration is illustrated in FIG. 1. The printheads may be arranged in a staggered configuration, in which the printheads are partially offset from an ink printhead along an axis coincident with media advance direction 54.

A controller 62 based on an electronic processor unit is configured for being operatively connected to the above described elements of printing system 10 as well as a memory device 64 and a printjob source 66. Controller 62 is configured to execute methods according to the present disclosure.

Controller 62 may be implemented, for example, by one or more discrete modules (or data processing components) that are not limited to any particular hardware, firmware, or software (i.e., machine readable instructions) configuration. Controller 62 may be implemented in any computing or data processing environment, including in digital electronic circuitry, e.g., an application-specific integrated circuit, such as a digital signal processor (DSP) or in computer hardware, firmware, device driver, or software (i.e., machine readable instructions). In some implementations, the functionalities of the modules are combined into a single data processing component. In other versions, the respective functionalities of each of one or more of the modules are performed by a respective set of multiple data processing components.

Memory device 64 is accessible by controller 62. Memory device 64 stores process instructions (e.g., machine-readable code, such as computer software) for implementing methods executed by controller 62 as well as data that controller 62 generates or processes such as alignment correction data. Memory device 64 may include one or more tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices.

Controller 62 receives printjob commands and data from printjob source 66, which may be a computer or any other source of printjobs, in order to print an image. In the example, controller 62 is configured to determine a print mask from the received data. The received data itself may already correspond to a print mask. A print mask refers to logic that includes control data determining which nozzles of the different printheads are fired at a given time to eject fluid in order to reproduce the printjob. Controller 62 is operatively connected to treatment printheads 46, 48, ink printheads 38-44, and the respective reservoirs to control, according to the print mask: a) ejection of ink 56 and treatment fluid 58, and b) motion of carriage 28 and print medium 1. The print mask may be stored in memory device 64.

FIG. 3 is a block diagram of a portion of printing system 10 illustrating an example of printhead firing control. The example is illustrated for a printhead 67, which may correspond to a treatment printhead (e.g., any of treatment printheads 46, 48) or to an ink printhead (e.g., any of ink printheads 38, 40, 42, 44). Controller 62 may provide a print mask 70 to a pulser 68. Pulser 68 may be located on or off printhead 67 depending on the particular printing system. Pulser 68 may process data from print mask 70 to generate pulses that controls an ink ejection element (IEE) array 71 associated to nozzle array 26. IEE array 71 includes IEEs (not shown) operatively coupled to a nozzle or a group of nozzles in nozzle array 26. In the illustrated example, controller 62 provides firing data to pulser 68 on two lines: i) a rate line 72 for setting the pulse rate; and ii) a gate line 74 for setting which pulses are to be forwarded to a particular IEE. Electrodes (not shown) on carriage 28 may forward the pulses.

The particular fluid ejection mechanism within the printhead may take on a variety of different forms such as those using piezo-electric or thermal printhead technology. For example, if the fluid ejection mechanism is based on a thermal printhead technology, the pulses forwarded to an IEE of IEE array 71 may be forwarded as a current pulse that is applied to a resistor within the particular IEE. The current pulse causes a fluid droplet (not shown), formed with fluid (i.e., ink or treatment fluid) from a fluid reservoir 76 (e.g., ink reservoir 60 or treatment fluid reservoir 61), to be emitted from the nozzle associated with the particular IEE.

FIG. 3 further illustrates a particular arrangement of a printhead 67. The depicted elements of printhead 67 are not to scale and are exaggerated for simplification. Printhead 67 includes a nozzle array 26 formed by individual nozzles 78. Nozzles 78 may be of any size, number, and pattern. A fluid ejection chamber (not shown) may be located behind nozzles 78 and contains IEEs associated to nozzles 78. A specific group of nozzles (hereinafter referred to as a primitive 80) may be allocated for being fired simultaneously. Nozzle array 26 may be arranged into any number of multiple subsections with each subsection having a particular number of primitives operated by a particular number of IEEs. In the illustrated example, printhead 67 has 192 nozzles with 192 associated firing IEEs; the 192 nozzles (nozzles 1 to 192) are allocated in 24 primitives (primitives P1 to P24) arranged in two columns of 12 primitives each.

The length of the rows of nozzles along the media advance direction defines a print swath 82. The width of this band along media advance direction 54 is commonly referred to as the “swath width,” which defines the maximum pattern of ink or fixer fluid which can be laid down in a single transition of carriage 28.

A printer such as printing system 10 can operate according to several different print modes. For example, in a single-pass print mode, after each printing pass the media is advanced a distance equal to the full span of a nozzle array (i.e., a swath width), such that each pass forms a complete strip of the image on the print medium. In a multi-pass print mode, the media only advances a fraction of the total length of a nozzle array after each printing pass of the printheads. For example, the media may be advanced a length corresponding to the length of a primitive 80. Thereby, each strip of the image to be printed is formed in successive passes of the printheads.

Ink may be applied when the carriage travels in one direction along the scan axis of carriage 28. Alternatively, printing may be bidirectional in that ink may be applied on a print area when the carriage travels in a “forward pass” and also when travelling in a “backward pass.” The print medium may be advanced after each pass or after both passes have been completed. Bidirectional printing is illustrated below with respect to FIGS. 6A to 9D. Bidirectional printing may improve print quality since only a fraction of the required amount of ink for a print area is applied in each pass. The lower the amount of applied ink in a pass, the lower the time required for the applied ink to be fixed to the substrate is. A fast ink fixing prevents undesired effects caused by ink migration such as color bleed, coalescence or feathering.

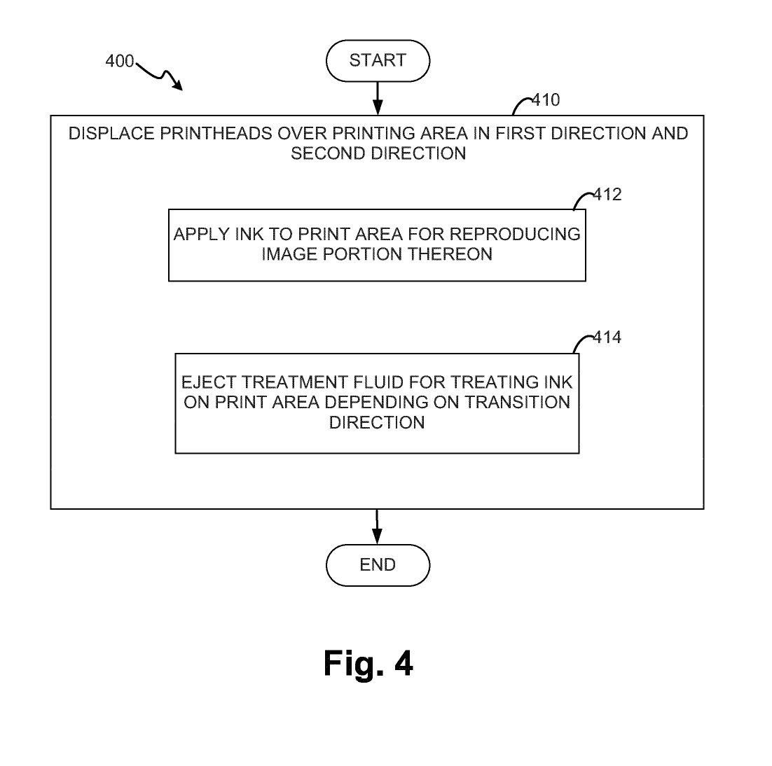

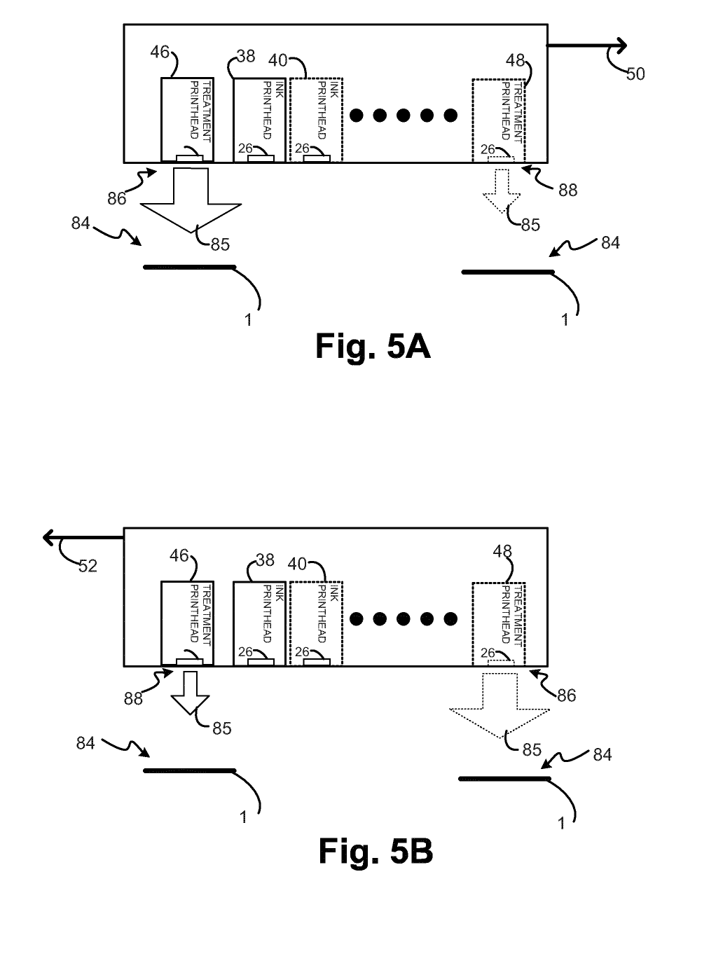

FIG. 4 is a process flow diagram of a method performed by a printing system according to an example herein. The depicted process flow 400 may be carried out by execution of sequences of executable instructions. In an example, the executable instructions are stored in a tangible machine readable storage medium such as, but not limited to, memory device 64. Process flow 400 may be carried out by controller 62 or any other suitable element of a printing system. In the following, process flow 400 is described with reference to elements depicted in FIGS. 5A, and 5B. These Figures are simplified diagrams of arrangements for a printing process.

At step 410 an ink printhead and a treatment printhead are simultaneously displaced over a print area in a first direction and a second direction. For example, controller 62 may operate carriage drive 32 for displacing carriage 28 across print medium 1 so as to forth and back traverse over print area 84, i.e. in forward direction 50 and in backward direction 52. The forward transition is illustrated in FIG. 5A; the backward transition is illustrated in FIG. 5B. During step 410, in one direction a treatment printhead is at a trailing position 86 relative to the treatment printheads, and in the other direction the treatment printhead is at a leading position 88 relative to the ink printheads. Generally, the first and the second directions are opposite directions.

In which direction the treatment printhead trails or leads depends on the particular printhead arrangement. In FIGS. 5A and 5B, two examples of printhead arrangements are illustrated. The first arrangement corresponds to elements depicted in solid lines. In the first arrangement, a single treatment printhead 46 trails behind a set of ink printheads 38, 40 in the forward transition (FIG. 5A) and leads in the backward transition (FIG. 5B). The second arrangement corresponds to elements depicted in solid and dotted lines. In the second arrangement, at the forward transition, treatment printhead 46 trails behind the set of ink printheads 38, 40 and treatment printhead 48 leads before thereof; at the backward transition, treatment printhead 46 leads before the set of ink printheads 38, 40 and treatment printhead 48 trails behind thereof.

Step 410 may include a step 412 at which ink is applied to the print area for reproducing an image portion thereon. For example, at step 412 controller 62 may operate ink printheads 38, 40, 42, 44 to apply ink 56 for reproducing a portion of an image (e.g., printing pattern 36) as described above. It will be understood that during step 412 ink may be applied continuously or intermittently. Further, ink may be applied during the transition in one or both of the first and second direction.

Step 410 includes a step 414 at which treatment fluid for treating print area 84 is ejected from a treatment printhead depending on the direction in which the treatment printhead travels. Treatment fluid may be applied to the print area before, quasi-simultaneously to or after ink application as illustrated in the examples below. It will be understood that the treatment printhead may eject treatment fluid continuously or intermittently during its displacement at step 410.

As illustrated in FIGS. 5A and 5B, generally, a specific amount of treatment fluid is ejected from a treatment printhead during step 410 for treating print area 84. The amount of treatment fluid ejected during transition in a particular direction is illustrated by the size of arrows 85. In this particular example, a portion of the treatment fluid amount to be ejected by a treatment printhead over print area 84 is ejected while the treatment printhead is at trailing position 86. Thereby, the risk of cross-contamination is reduced as compared to ejecting treatment fluid only while a treatment printhead is at a leading position 88. In some examples, the majority (i.e., more than 50%) of the treatment fluid amount to be ejected by a treatment printhead over print area 84 is ejected while the treatment printhead is at trailing position 86. In other examples herein, the entire amount of treatment fluid to be ejected by a treatment printhead over print area 84 is ejected while the treatment printhead is at trailing position 86.

FIGS. 6A to 7C illustrate examples of bidirectional printing across print medium 1. In these examples, carriage 28 traverses across a printing surface 90 of print medium 1 for reproducing printing patterns 600, 700 thereon by applying ink and treatment fluid to a plurality of print areas. First, carriage 28 traverses in forward direction 50 (in the examples shown as a left-to-right direction). Secondly, carriage 28 traverses in a backward direction 52 (in the examples shown as a right-to-left direction). Thereby, carriage 28 traverses along a forward path 92 and a backward path 94. During this bidirectional transition, the treatment printheads ejects an amount of treatment fluid 96 in each of the print areas. The examples illustratively show that the same amount of treatment fluid is applied to each print area. However, different amounts of treatment fluid may be applied to the different print areas. The amount of treatment fluid to be applied to a print area may be selected taking into account, among other factors: a) the type of used ink and treatment; and b) the total amount of ink to be applied to each particular print area.

FIGS. 6A to 6C illustrate a printing process carried out by a printing system with a carriage 28 including a single treatment position receiving a treatment printhead 46. An ink printhead assembly 98 is disposed adjacent to treatment printhead 46. Ink printhead assembly 98 may include any number of ink printheads as described above aligned such that treatment printhead 46 leads or trails relative thereto depending on the carriage transition direction.

In some examples herein, and as illustrated by FIGS. 6A to 6B, the amount of treatment fluid to be applied to a print area is partially ejected while the carriage traverses in the direction in which the treatment printhead leads before the ink printhead. For example, as shown in FIG. 6A, a printing process may start by a carriage transition over printing surface 90 in forward direction 50. During the forward transition, treatment printhead 46 is at leading position 88 and applies a specific amount of treatment fluid 96a to each print area (see FIG. 6B). This specific amount is a portion of the treatment fluid to be applied to each print area. It will be understood that the treatment fluid to be applied to each print area may vary for each print area. During the backward transition, ink printhead applies ink 56 to the print areas. After carriage 28 traverses along forward path 92, the printing process further includes a carriage transition over printing surface 90 in backward direction 52. During the backward transition, treatment printhead 46 is at trailing position 86 and applies a specific amount of treatment fluid 96b to each print area. Since ink printhead assembly 98 is at leading position 88 during the backward transition, it applies ink 56 an instant before the application of treatment fluid amount 96b (see FIG. 6C). In order to prevent cross-contamination, treatment fluid amount 96a (ejected at leading) at a particular print area is lower than treatment fluid amount 96b at the particular print area (ejected at trailing).

In this example, controller 62 is configured to operate treatment printhead 46 for applying a first amount of treatment fluid (i.e., treatment fluid amount 96a) while leading and a second amount of treatment fluid (i.e., treatment fluid amount 96b) at trailing. Thereby, further to preventing cross-contamination, it is facilitated that some treatment fluid is applied to each print area quasi-simultaneously (i.e., at the same pass) to ink application in order to promote a more efficient treatment of deposited ink. Further, in a configuration in which a single treatment printhead leads relative to an ink printhead at a forward pass, as shown in FIGS. 6A to 6C, ejecting some treatment fluid at leading prevents that ink ejected during the forward pass remains untreated until treatment fluid ejection at the backward pass.

In a configuration with a single treatment printhead, the amount of treatment fluid ejected during a pass in which the single treatment printhead is at leading relative to the ink printhead(s) is chosen such that a) the amount is sufficiently low so as to prevent cross-contamination, and b) the amount is sufficiently high so as to sufficiently treat ink on the print medium before a still higher amount of treatment fluid is ejected in the following pass. This minimum amount may be chosen depending on the amount of ink already applied. In one example, the ejected treatment fluid at leading is 1/P of the total amount of ejected treatment fluid, where P is the number of passes; the ejected treatment fluid at trailing is (P−1)/P of the total amount of ejected treatment fluid. Thereby, it is facilitated an effective treatment of ink on the print medium while preventing cross-contamination.

The specific amount of treatment fluid to be applied to a particular print area may be completely ejected while the carriage traverses in the direction in which the treatment printhead trails behind the ink printhead. In other words, in such examples, treatment fluid is ejected from a particular treatment printhead only while the particular treatment fluid printhead is at trailing. Thereby, cross-contamination is further prevented since the risk of cross-contamination caused by a leading treatment printhead ejecting fluid is avoided. In the above example, such a printing process may be executed by ejecting only treatment fluid amount 96b. Such a printing process may be performed by alternatively ejecting treatment fluid from treatment printheads disposed at different sides of an ink printhead assembly. For example, processor 62 may be configured to operate treatment printheads 46, 48 for ejecting treatment fluid only while trailing behind ink printheads 38, 40, 42, 44. Such a double treatment printhead configuration, as further illustrated in FIGS. 7A to 7C, facilitates quasi-simultaneous treatment of ink at each pass without increasing cross-contamination risk since a treatment printhead can be operated at trailing during each pass.

FIGS. 7A to 7C show a printing process carried out by a printing system with a carriage 28 including two treatment positions respectively receiving treatment printheads 46, 48. An ink printhead assembly 98 is disposed in-between treatment printheads 46, 48. Ink printhead assembly 98 may include any number of ink printhead as described above. At each pass, a treatment printhead leads and the other treatment printhead trails relative to ink printhead assembly 98.

During the carriage transition across printing surface 90, each of the treatment printheads ejects a particular amount of treatment fluid over each print area. Further, each of the treatment printheads completely ejects the respective amount of treatment fluid for each print area while trailing behind ink printhead assembly 98. For example, as shown in FIG. 7A, a printing process starts by a carriage transition over printing surface 90 in forward direction 50. As illustrated in FIG. 7A, during the forward transition treatment printhead 46 (highlighted bold) is at trailing position 86 and applies a specific amount of treatment fluid 96a to each print area; further, treatment printhead 48 is at leading position 88 and does not eject treatment fluid. Further, as illustrated in FIG. 7B, during the backward transition treatment printhead 46 is at leading position 88 and does not eject treatment fluid; further, treatment printhead 48 (highlighted bold) is at trailing position 86 and applies a specific amount of treatment fluid 96b to each print area. In this example, amounts 96a, 96b are illustrated as being equal. It is also contemplated that each treatment printhead ejects a different total amount of treatment fluid over a particular print area.

FIGS. 8A to 8C and 9A to 9D illustrate some examples of arrangements for a printing process and printed patterns. The illustrated print modes correspond to multi-pass bidirectional printing modes, namely print modes in which the print medium only advances a fraction of the total length of the nozzle array in a printhead and nozzles are operated during both the forward and backward transitions.

The examples particularly illustrate eight pass bidirectional print modes, i.e., four passes in a forward direction and four passes in a backward direction. In such print modes, the nozzles arrays in the printheads may be arranged with nozzle groups arranged extending along the media advance direction. Nozzles in a nozzle group are simultaneously fired. At each pass, a nozzle group ejects ink or treatment fluid over a particular print area corresponding to a fraction of the whole print swath. For example, each nozzle group may correspond to a pair of primitives illustrated in FIG. 3. Such a sequential deposition of ink and treatment fluid on a print area facilitate ink fixation to the print medium by depositing fractional amounts of ink and avoid cross-contamination by selectively applying fractional amounts of treatment fluid depending on the pass direction.

FIGS. 8A to 8C illustrate a print mode carried out with a single printhead configuration analogous to that of FIGS. 6A to 6C. As illustrated in FIG. 8A an ink printhead assembly 98 is arranged adjacent to a single treatment printhead 46 and aligned thereto in the direction of carriage transition. The nozzles in ink printhead assembly 98 are distributed in eight nozzle groups P1 to P8 defining a print swath 82. The nozzles in treatment printhead 46 are distributed in four nozzle groups P1 to P4. It will be understood that in other examples, treatment printheads 46, 48 and ink printhead assembly 98 may include any number and distribution of nozzle groups suitable for a particular printing system. In particular, the treatment printheads may include the same number of nozzle groups than printheads in ink printhead assembly 98 include. Generally, nozzles in a group are fired simultaneously.

FIG. 8B illustrates usage of single treatment printhead 46 for applying treatment fluid on a whole print swath. During transition in forward direction 50, left treatment printhead 46 is at trailing and ejects a first portion 100 of the total amount of treatment fluid to be applied on a whole print swath. During transition in backward direction 52, single treatment printhead 46 is at leading and ejects a second portion 102 of the total amount of treatment fluid to be applied on a whole print swath. In order to prevent the cross-contamination first portion 100 is higher than second portion 102, so that the majority of treatment fluid is ejected when single treatment printhead 46 is at trailing relative to ink printhead assembly 98. In the illustrated example, ⅞ of the total amount is ejected at trailing and ⅛ of the total amount is ejected at leading.

FIG. 8C illustrates the process for depositing layers of ink and treatment fluid in a print swath 82 with the arrangement illustrated in FIG. 8A. The horizontal direction corresponds to layers deposited on a particular spot of print medium 1. The vertical axis corresponds to media advance direction 54. A print swath 82 is printed after eight passes (i.e., four passes in forward direction 50 and four passes in backward direction 52) are completed. The first pass direction is forward direction 50. After each pass, the print medium is advanced one eight of the whole swath in media advance direction 54 (Adv. 1 to Adv 8). Ink is ejected at each pass for depositing ink layers (depicted by hatched boxes in the Figure). Treatment fluid is ejected at the first four passes for depositing treatment fluid layers (depicted by dotted boxes in the Figure) according to: a) the number of nozzle groups in the illustrated treatment fluid printheads; and b) the relative arrangement between ink printhead assembly 98 and single treatment fluid printhead 46.

The number in each box denotes at which pass a particular layer is deposited. A double number in a box corresponding to a treatment fluid layer indicates a layer deposited by single treatment printhead 46 at trailing (i.e., at odd passes). A single number in a box corresponding to a treatment fluid layer indicates a layer deposited by single treatment printhead 46 at leading (i.e., at odd passes). As illustrated in FIG. 8B, a treatment fluid layer deposited at trailing contains a higher amount of treatment fluid than a treatment fluid layer deposited at leading.

In some examples performed with a single treatment printhead configuration, a treatment printhead leading in a particular pass does not eject treatment fluid over a particular area if the treatment printhead has already deposited a treatment fluid layer over the particular area. In the illustrated example of FIG. 8C, white boxes depicts such non-deposited treatment fluid layers. These layers are not deposited because, in the previous pass, the treatment printhead deposits at trailing a treatment fluid layer sufficiently high for treating also ink deposited on the following pass.

Depositing layers corresponding to white boxes may unnecessarily increase the risk of contamination. For example, in the illustrated printing process, at the first pass ink printhead assembly 98 deposits ink layer 1, and single treatment printhead 46 deposits a treatment layer 11 at trailing. At the second pass ink printhead assembly 98 deposits ink layer 2, and single treatment printhead 46 does not eject treatment fluid at leading since treatment layer 11 is sufficient for suitably treating ink layer 2 (e.g., for promoting fixation of ink layer 2 to the print medium).

A print mode as illustrated in FIGS. 8A to 8C prevents cross-contamination by implementation of a single treatment printhead and selectively ejecting different amounts of treatment fluid depending on whether the treatment printhead is at trailing or at leading.

FIGS. 9A to 9D illustrate a print mode carried out with a double printhead configuration analogous to that of FIGS. 7A to 7C. As illustrated in FIG. 9A, an ink printhead assembly 98 is arranged in-between a left treatment printhead 46 and a right treatment printhead 48 in the direction of carriage transition. The nozzles in ink printhead assembly 98 are distributed in eight nozzle groups P1 to P8 defining a print swath 82. The nozzles in treatment printheads 46, 48 are distributed in four nozzle groups P1 to P4. It will be understood that, in other examples, treatment printheads 46, 48 and ink printhead assembly 98 may include any number and distribution of nozzle groups suitable for a particular printing system. In particular, the treatment printheads may include the same number of nozzle groups than printheads in ink printhead assembly 98 include.

FIG. 9B illustrates usage of left treatment printhead 46 for applying treatment fluid on a whole print swath. During transition in forward direction 50, left treatment printhead 46 is at trailing and ejects 50% of the total amount of treatment fluid to be applied on a whole print swath. During transition in backward direction 52, left treatment printhead 46 is at leading and does not eject treatment fluid over the particular print area so as to prevent cross-contamination of ink printheads in ink printhead assembly 98.

FIG. 9C illustrates usage of right treatment printhead 48 for applying treatment fluid on a whole print swath. During transition in forward direction 50, right treatment printhead 48 is at leading and does not eject treatment fluid so as to prevent cross-contamination of ink printheads in ink printhead assembly 98. During transition in backward direction 52, right treatment printhead 48 is at leading and ejects 50% of the total amount of treatment fluid to be applied on the particular print area. At each of the forward and backward transition, ink printhead assembly 98 is operated for applying a portion of ink on the particular print area.

FIG. 9D illustrates the process for depositing layers of ink and treatment fluid in a print swath 82 with the arrangement illustrated in FIG. 9A. The horizontal axis corresponds to layers deposited on a particular spot of print medium 1. The vertical axis corresponds to media advance direction 54. A print swath 82 is printed after eight passes (i.e., four passes in forward direction 50 and four passes in backward direction 52) are completed. The first pass direction is forward direction 50. After each pass, the print medium is advanced one eight of the whole swath in media advance direction 54 (Adv. 1 to Adv 8). Ink is ejected at each pass for depositing ink layers (depicted by hatched boxes in the Figure).

Treatment fluid is ejected at the first four passes for depositing treatment fluid layers (depicted by dotted boxes in the Figure) according to a) the number of nozzle groups in the illustrated treatment fluid printheads, and b) the relative arrangement between the ink printheads and treatment fluid printheads. The number of each box denotes at which pass a particular layer is deposited. The subscript L in boxes corresponding to a treatment layer denotes a layer deposited by operation of left treatment printhead 46. As illustrated in FIG. 9B, left treatment printhead 46 performs deposition of treatment fluid at trailing, i.e. at odd passes. The subscript R in boxes corresponding to a treatment layer denotes a layer deposited by operation of right treatment printhead 48. As illustrated in FIG. 9C, right treatment printhead 48 performs deposition of treatment fluid at trailing, i.e. at even passes.

A print mode as illustrated in FIGS. 9A to 9D effectively prevents cross-contamination by implementation of a double treatment printhead and selectively ejecting of treatment fluid when a treatment printhead is at trailing.

The examples described above provide methods and systems for preventing cross-contamination. As discussed above, the examples may be successfully deployed in any printing system including a treatment printhead aligned, at least partially, with an ink printhead assembly in a traversing direction as described above. However, examples may be particularly used in industrial inkjet printers implementing ink treatment. Industrial printers are, generally, more prone to cross-contamination by generation of aerosol in view of the involved sizes and/or production rates. Further, examples may be particularly used in printers characterized by a relatively high printhead-to- medium distance since such systems may be more prone to cross-contamination caused by treatment fluid ejected for treating printing ink. Such relatively high printhead-to-medium distances may be of at least 2 mm or, more particularly, between 2 mm and 4 mm such as 2.3 mm.

Further, the examples may be successfully deployed for any treatment fluid. However, examples may be particularly used when the treatment fluid is a fixer fluid for preventing ink migration on a print medium. As used herein, “fixer fluid” refers to a solution composition that includes a liquid vehicle and a fixing agent for preventing ink migration on a print medium. The solution composition may be configured to be chemically stable and/or for ink-jet printing. The fixing agent may be a cationic polymer, a multivalent metal ion or ionic group and/or an acid. The fixing agent may precipitate with at least one compositional component of an associated ink. Some examples of fixer fluid are described in U.S. Pat. No. 6,585,364, U.S. Pat. No. 7,621,631, U.S. Pat. No. 6,821,329, or U.S. patent application with application number US2005/0231573. Cross-contamination caused by a fixer fluid may be particularly prejudicial since it may lead to fixation of ink at the nozzles exit thereby clogging a printhead.

In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the true spirit and scope of the disclosed examples.

What is claimed is:

1. A method of printing, comprising:
displacing a carriage (28) including an ink printhead (38, 40, 42, 44) and a treatment printhead (46, 48) such that the carriage traverses over a print area (84) in a forward direction (50) and a backward direction (52), wherein in one of the forward direction or the backward direction the treatment printhead trails behind the ink printhead, and in the other direction the treatment printhead leads before the ink printhead;
the method further comprising, during the carriage transition over the print area:
applying ink (56) from the ink printhead to the print area for reproducing an image portion on the print area; and
ejecting treatment fluid (58) from the treatment printhead for treating the print area such that a portion or all of the treatment fluid ejected for treating the print area is ejected while the treatment printhead trails behind the ink printhead.

2. The method of claim 1, wherein ejecting treatment fluid (58) for treating the print area is such that most or all of the treatment fluid ejected for treating the print area is ejected while the treatment printhead trails behind the ink printhead

3. The method of claim 1, wherein ejecting treatment fluid (58) includes ejecting treatment fluid only while the carriage (28) traverses in the direction in which the treatment printhead (46, 48) trails behind the ink printhead (38, 40, 42, 44).

4. The method of claim 1, wherein:
the carriage (28) includes at least two treatment printheads (46, 48) and at least one ink printhead (38, 40, 42, 44) disposed between the at least two treatment printheads such that one of the treatment printheads trails behind the at least one ink printhead and another of the treatment printheads leads before the at least one ink printhead depending on the direction of the carriage transition; and, during the carriage transition over the print area:
each of the treatment printheads ejects an amount of treatment fluid (58); and
each of the treatment printheads ejects treatment fluid only while trailing behind the at least one ink printhead.

5. The method of claim 1, wherein treatment fluid (58) is ejected while the carriage traverses in the direction in which the treatment printhead leads before the ink printhead.

6. The method of claim 5, wherein ejecting treatment fluid for treating the print area includes ejecting at least 1/P of the ejected treatment fluid (58) while the carriage (28) traverses in the direction in which the treatment printhead (46, 48) leads before the ink printhead (38, 40, 42, 44), where P is the number of passes in which the treatment printhead ejects treatment fluid over the print area.

7. The method of claim 5, wherein ejecting treatment fluid for treating the print area includes ejecting treatment fluid from a treatment printhead being the single treatment printhead (46) at the carriage (28).

8. The method of claim 1, wherein the printing is performed using a carriage (28) of an industrial inkjet printer.

9. The method of claim 1, wherein the distance between an outlet (26) of the treatment printhead and the print medium (1) is at least 2 mm.

10. The method of claim 1, wherein the ink printhead (38, 40, 42, 44) and the treatment printhead (46, 48) are aligned with respect to each other along the direction of carriage transition.

11. A printing system (10) comprising:
a processor (62) to operate a carriage (28), the carriage including a plurality of positions for receiving respective printheads, including an ink position for receiving an ink printhead (38, 40, 42, 44) and a treatment position for receiving a treatment printhead (46, 48), the treatment position trailing behind the ink position when the carriage moves in one of a first direction or a second direction and leads before the ink position when the carriage moves in the another direction,
wherein the processor is configured to
operate the carriage to traverse over a print area (84) in the first direction and the second direction,
control the ink printhead to apply ink (56) to the print area (84) for reproducing an image portion thereon; and
control the treatment printhead to eject treatment fluid (58) for treating the print area (84) depending on the traversing direction.

12. The printing system according to claim 11, wherein the processor (62) is configured to, during the carriage transition over the print area (84), control the treatment printhead (46, 48) to apply most of the treatment fluid for treating the print area while the treatment position trails behind the ink position.

13. The printing system (10) according to claim 11, wherein the carriage (28) includes at least two treatment positions for receiving respective treatment printheads (46, 48) and at least one ink position for receiving an ink printhead (38, 40, 42, 44) disposed between the two treatment positions such that one of the treatment positions trails behind the at least one ink position and another of the treatment positions leads before the at least one ink position while the carriage moves in one of the first direction and the second direction.

14. The printing system (10) according to claim 13, wherein the processor (62) is further configured to, during the carriage transition over the print area (84), operate the treatment printheads (46, 48) in the at least two treatment positions for ejecting treatment fluid only while the associated treatment position trails behind the ink position.

15. The printing system according to claim 11, wherein the carriage (28) includes a single treatment position for receiving a treatment printhead (46).

16. The printing system according to claim 15, wherein the processor (62) is further configured to, during the carriage transition over the print area (84), operate a treatment printhead (46) in the single treatment position for applying a first amount (100) of treatment fluid while the single treatment position trails behind the ink position and a second amount (102) of treatment fluid while the single treatment position leads before the ink position.

17. The printing system according to claim 16, wherein the first amount is higher than the second amount.

18. A tangible machine readable storage medium (64) storing instructions that, when executed by a processor (62), implements a method at a printing system (10), the method comprising:
simultaneously displacing an ink printhead (38, 40, 42, 44) and a treatment printhead (46, 48) across a print area (84) in two opposite directions (50, 52) such that, in one direction, the treatment printhead is at a trailing position (86) relative to the treatment printhead and, in the another direction, the treatment printhead is at a leading position (88) relative to the treatment printhead;
ejecting an amount of treatment fluid (58) from the treatment printhead for treating the print area, most or all of the treatment fluid amount being ejected while the treatment printhead is at a trailing position.
